(19) United States
(12) Patent Application Publication
(10) Pub. No.: US 2015/0151732 A1
(43) Pub. Date: Jun. 4, 2015

(54) SYSTEM AND METHOD FOR CONTROLLING FUZZY ENGINE CLUTCH OF HYBRID VEHICLE

(71) Applicant: Hyundai Motor Company, Seoul (KR)

(72) Inventor: Do Hee Kim, Hwaseong (KR)

(21) Appl. No.: 14/445,622

(22) Filed: Jul. 29, 2014

(30) Foreign Application Priority Data
Dec. 4, 2013 (KR) 10-2013-0149626

(51) Int. Cl. B60W 10/02; B60W 10/06; F16D 48/02

(52) U.S. Cl. CPC B60W 10/02; F16D 48/02; B60W 10/06

(57) ABSTRACT

A system and method for controlling an active fuzzy engine clutch of a hybrid vehicle enable a force (pressure) capable of jointing an engine clutch with output information of a fuzzy system to be generated by using dynamic state information as input information in the fuzzy system. The system includes: a load torque calculator for calculating a load torque based on a load difference of a load subject and a compensation subject, and compensating the load torque for the compensation subject; a torque controller for transferring output information for a power source, and controlling a transmission ratio; and an engine clutch joint control fuzzy controller for determining a hydraulic pressure for jointing an engine clutch based on torque information input from the torque controller, including load torque information input from the load torque calculator.

### CROSS-REFERENCE TO RELATED APPLICATION

This application claims under 35 U.S.C. §119(a) the benefit of Korean Patent Application No. 10-2013-0149626 tiled on Dec. 4, 2013, the entire contents of which are incorporated herein by reference.

### BACKGROUND

(a) Technical Field

The present invention relates to a system and method for controlling a fuzzy engine clutch of a hybrid vehicle. More particularly, the present invention relates to a system and method for controlling an active fuzzy engine clutch of a hybrid vehicle, by which a force (pressure) capable of jointing an engine clutch with output information of a fuzzy system can be generated by using dynamic state information as input information in the fuzzy system.

(b) Description of the Related Art

A hybrid vehicle refers to an environment-friendly vehicle in which various power transmission structures can be configured by using two or more power sources including an engine and a motor, and most hybrid vehicles employ parallel or serial power transmission structures.

Referring to FIG. 1, in a power train for a parallel hybrid vehicle, an engine 10, an ISG (In grated Starter & Generator) 20, a wet multi-plate type engine clutch 30, a motor 40, and a transmission 50 are sequentially arranged on one axis, and a battery 70 is connected to the motor 40 and the ISG 20 through an inverter 60 to be charged or discharged.

In a hybrid vehicle employing an engine and a motor, the motor 40 is driven when the vehicle initially starts (by using characteristics of a motor preferably having an excellent efficiency at a low RPM), and if the vehicle travels at a predetermined speed or higher, a generator, that is, the ISG 20 starts up the engine, and the engine clutch 30 is operatively coupled to the engine such that both an output of the engine and an output of the motor are used at the same time.

In particular, a hybrid vehicle includes an EV operation mode in which the vehicle is driven only by a driving force of the motor 40 while the engine clutch 30 between the engine 10 and the motor 40 is unengaged, and an HEV operation mode in which powers of the engine 10 and the motor 40 are transmitted to the driving shaft while the engine clutch 30 is unengaged, and in which frequent transitions of travel modes to an EV operation mode or to an HEV operation mode can occur through joint of the engine clutch according to a torque required by a driver during driving of the vehicle.

When the EV operation mode is converted into the HEV operation mode, that is, at a time point when a driving power of the engine is necessary, there is a need to control synchronization of the engine clutch by which the engine clutch is engaged when a speed (RPM) of the engine and a speed (RPM) of the motor are synchronized, and to properly control a hydraulic pressure for operating the engine clutch.

Conventionally, in order to properly control a hydraulic pressure for engaging an engine clutch, a wet type clutch employs a method of recognizing a torque transmission time point through learning of a kiss point and learning of a transmission torque, and adjusting and compensating a deviation and frictional energy during joint of the engine clutch by using a hydraulic sensor. However, since a value used in learning is a past value, a real time correspondence is impossible. Further, since it is uncertain to control a hydraulic pressure having a nonlinear tendency, the control of the hydraulic pressure is disadvantageous in coping with an impact such as a jerk and a surge during the joint.

### SUMMARY

The present invention provides a system and method for controlling a fuzzy engine clutch of a hybrid vehicle by which a force (pressure) capable of jointing the engine clutch by using a fuzzy system has a real time feedback function and is robust to nonlinearity while taking dynamic phenomena (a load torque, a change in load torque, and the like) when the engine clutch is jointed in an open state.

A system for controlling a fuzzy engine clutch of a hybrid vehicle, the system including: a load torque calculator for calculating a load torque based on a load difference of a load subject and a compensation subject, and compensating the load torque for the compensation subject; a torque controller for transferring output information for a power source, and controlling a transmission ratio; and an engine clutch joint control fuzzy controller for determining a hydraulic pressure for jointing an engine clutch based on torque information input from the torque controller, including load torque information input from the load torque calculator.

The fuzzy controller may include: a transfer torque index defining unit for defining a transfer torque index that is a parameter that associates a torque of input information with a hydraulic pressure of output information; a hydraulic pressure calculating unit for calculating a hydraulic pressure by which a necessary torque for jointing the engine clutch can be transferred by using the defined transfer torque index; and a determined hydraulic pressure output unit for determining and outputting a fine hydraulic pressure increment and a fine hydraulic pressure decrement, including a base hydraulic pressure.

In accordance with another aspect of the present invention, there is provided a method of controlling a fuzzy engine clutch of a hybrid vehicle, the method including: a step of calculating a load torque based on a load difference of a load subject and a compensation subject, and calculating the load torque for compensating a load torque for the compensation subject; and a fuzzy control step of determining a hydraulic pressure for jointing an engine clutch based on the calculated load torque information and torque information input from a torque controller.

The fuzzy control step may include: a step of defining a transfer torque index that is a parameter that associates a torque of input information with a hydraulic pressure of output information; a step of calculating a hydraulic pressure by which a necessary torque for jointing an engine clutch can be transferred by using the defined transfer torque index; and a determined hydraulic pressure output step of determining a hydraulic pressure increment and a hydraulic pressure decrement, including a base hydraulic pressure for jointing the engine clutch, based on the transfer torque index and a hydraulic pressure for transferring a necessary torque.

The transfer torque index (H) may be defined by [Demanding torque−Motor torque/Engine torque+Motor torque+Engine clutch load torque].

The hydraulic pressure by which a necessary torque can be transferred by using the transfer torque index (H) may be calculated by [P=H*Pmax], and Pmax is a hydraulic pressure that can be generated when a load torque is “0”.

A hydraulic pressure increment (Del P) for satisfying a joint target in addition to a base hydraulic pressure (P_base) for jointing the engine clutch may be determined through [Del P=H*(Pmax−P_base)].

A non-transitory computer readable medium containing program instructions executed by a processor on a controller may include: program instructions that calculate a load torque based on a load difference of a load subject and a compensation subject, and calculate a load torque for compensating the load torque for the compensation subject; and program instructions that determine a hydraulic pressure for jointing an engine clutch based on the calculated load torque information and torque information input from a torque controller, so as to control a fuzzy engine clutch of a hybrid vehicle. Further, the computer readable medium may include: program instructions that define a transfer torque index that is a parameter that associates a torque of input information with a hydraulic pressure of output information; program instructions that calculate a hydraulic pressure by which a necessary torque for jointing an engine clutch can be transferred by using the defined transfer torque index; and program instructions that determine a hydraulic pressure increment and a hydraulic pressure decrement, including a base hydraulic pressure for jointing the engine clutch, based on the transfer torque index and a hydraulic pressure for transferring a necessary torque.

The present invention can provide the following effects.

First, accuracy for control of joint of an engine clutch can be increased by using a fuzzy system that enables a real time feedback and is robust to nonlinearity.

Second, an engine clutch controller may be realized regardless of a type of an engine clutch.

In particular, a target determined and output by a fuzzy controller for controlling joint of an engine clutch is a force, and the force may be a thrust by a hydraulic pressure or a motor. Accordingly, if a force value is adjusted according to physical characteristics of an output value of an engine clutch system, the present invention can be used in control joint of a clutch regardless of a wet type or a dry type clutch.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 (PRIOR ART) is a power transmission system diagram of a hybrid vehicle;

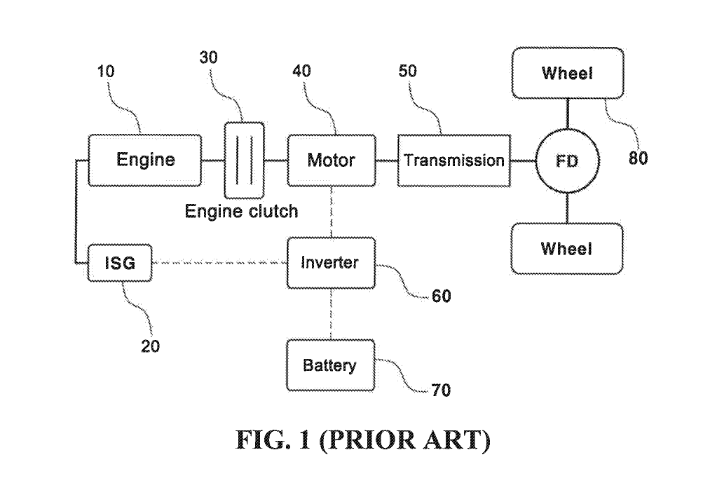

FIG. 2 is a diagram showing a fuzzy engine clutch control system of a hybrid vehicle according to the present invention;

FIG. 3 is a graph showing a method of calculating and compensating a load torque for controlling the fuzzy engine clutch of a hybrid vehicle according to the present invention; and

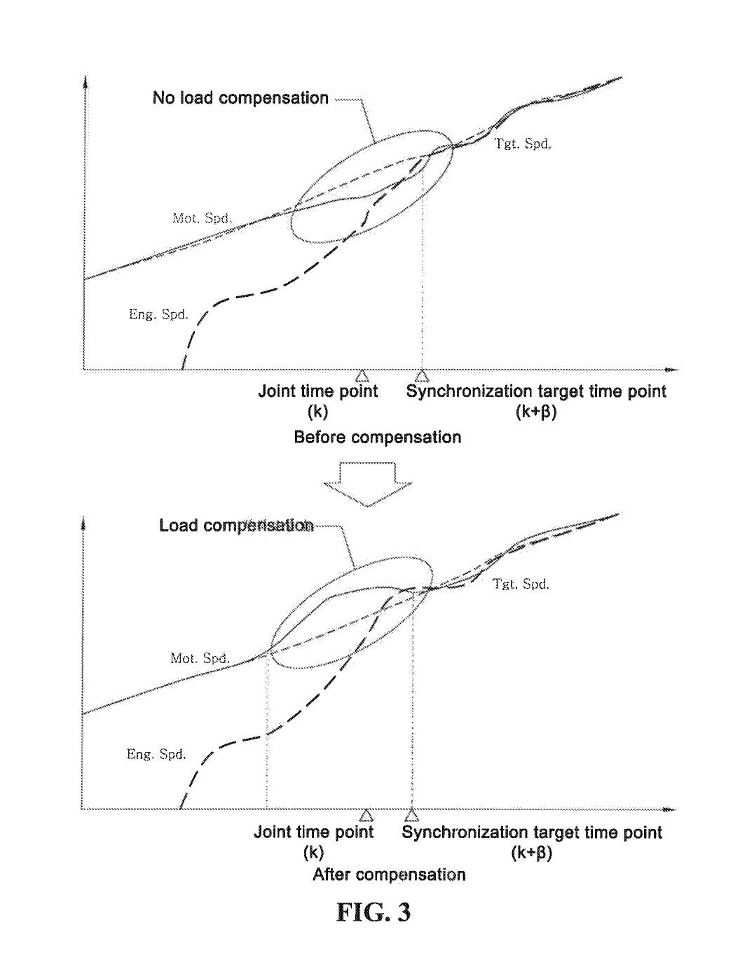

FIG. 4 is a schematic view showing an example of compensating a load torque for controlling the fuzzy engine clutch of a hybrid vehicle according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, exemplary embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

According to the present invention, dynamic state information of an engine clutch is used as input information of a fuzzy controller, and a force for jointing the engine clutch is determined by a fuzzy controller based on the input information.

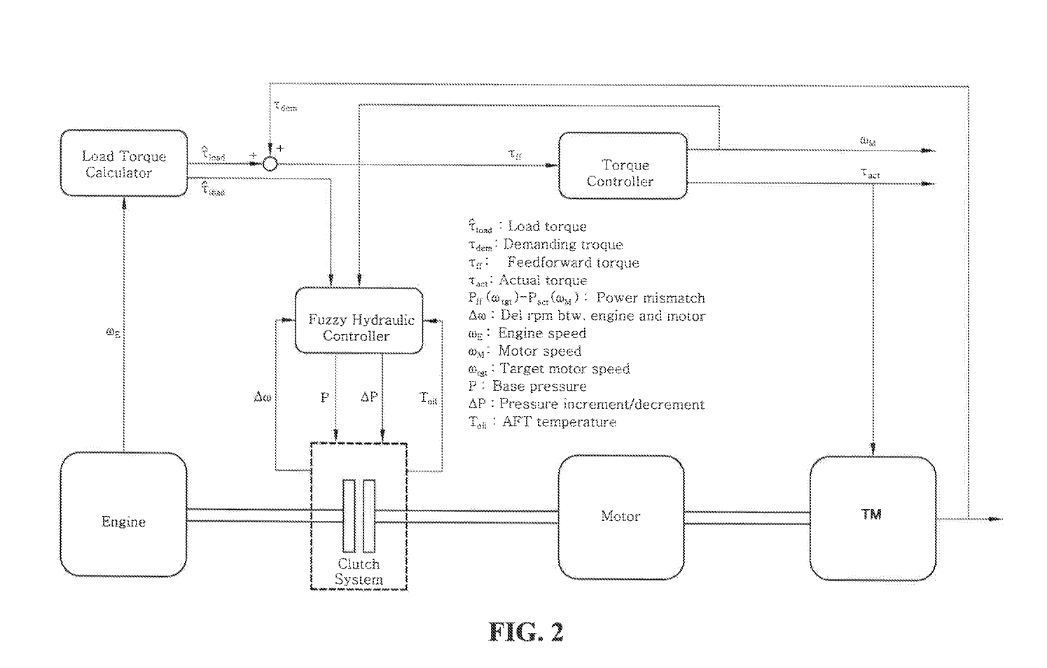

FIG. 2 is a diagram showing a system for controlling a fuzzy engine clutch of a hybrid vehicle according to the present invention.

As shown in FIG. 2, the system for controlling a fuzzy engine clutch according to the present invention includes a load torque calculator, a torque controller for transferring output information for a power source to control a gear ratio, and determining a regenerative braking amount, and an engine clutch joint control fuzzy controller for determining a base force (hereinafter, referred to as hydraulic pressure) for joint of an engine clutch and a fine hydraulic increment and a fine hydraulic decrement based on torque information input from the torque controller, including a load torque input from the load torque calculator.

In particular, the fuzzy controller includes a transfer torque index defining unit for defining a transfer torque index, that is, a parameter that associates a torque of input information with a hydraulic pressure of output information, a hydraulic pressure calculator for calculating a hydraulic pressure capable of transferring a necessary torque for joint of an engine clutch by using a defined transfer torque index, and a determined hydraulic pressure output unit for outputting a fine hydraulic pressure increment and a fine hydraulic pressure decrement including a base hydraulic pressure.

A method of controlling a fuzzy engine clutch of a hydraulic vehicle according to the present invention based on the configuration will be described.

First, a load torque difference (Δ load torque) including load torque information calculated based on a load difference between a load subject and a compensation subject is input from the load torque calculator to an engine clutch joint control fuzzy controller, and a difference between a target load hydraulic pressure and an actual load pressure, that is, between a target load power (Pff) and an actual load power (Pact) is input from the torque controller as torque information for controlling the transmission.

A process of calculating a load torque based on a load difference of a load subject and a compensation subject by the load torque calculator will be described in detail in the following, and if the motor is a load subject, a compensation subject that is a load torque compensation object is an engine, and to the contrary, if the engine is a load subject, a compensation subject that is a load torque compensation object is a motor.

A difference between a target load power and an actual load power, including a load torque input to the fuzzy controller is for determining a hydraulic pressure and a joint speed according to compensation of a load torque.

The reason why a load torque difference is input to the fuzzy controller is because a jerk and surge phenomenon can be prevented by adjusting a hydraulic pressure through recognition of a state between opposite ends of the engine clutch.

Next, the fuzzy controller determines and outputs a hydraulic pressure for jointing an engine clutch based on torque information input from the torque controller, including load torque information input from the torque calculator.

Thereto, first, the transfer torque index defining unit of the fuzzy controller defines an index informing of a torque that needs to be transferred to the clutch to an entire torque as in Equation 1.

Transfer torque index (H)=Demanding torque−Motor torque/Engine torque+Motor torque+Engine clutch load torque Equation 1

Next, a hydraulic pressure (P) by which a necessary torque can be transferred by using the transfer torque index (H) defined as in Equation 1 is calculated by the hydraulic pressure calculating unit of the fuzzy controller.

P=H*Pmax

Then, the demanding torque is [Demanding torque−Motor torque], and refers to a torque that should be transferred to a driving shaft by jointing an engine clutch.

In Equation 2, Pmax is a hydraulic pressure that can be generated when a load torque is “0”. In particular, the entire torque is transferred to generate a hydraulic pressure P when Pmax is generated.

Next, a step of determining and outputting a fine hydraulic pressure increment and a fine hydraulic pressure decrement, including a base hydraulic pressure, is performed in a determined hydraulic pressure output unit of the fuzzy controller.

In particular, a fine hydraulic pressure increment and a fine hydraulic pressure decrement, including a base hydraulic pressure for jointing the engine clutch are determined and output based on load torque information input from the load torque calculator and torque information input from the torque controller.

An embodiment of determining and outputting a fine hydraulic pressure increment and a fine hydraulic pressure decrement, including a base hydraulic pressure, by the determined hydraulic, pressure output unit of the fuzzy controller will be described while taking a wet type engine clutch as an example.

For reference, an open state of a clutch refers to a state in which opposite end shafts of the engine clutch do not interfere with each other and the clutch is physically separated, and a lock-up state of the clutch refers to a state in which speeds of opposite ends of the clutch are not different and a torque applied to an input shaft is transferred to an output shaft by 100%.

If a load torque by which a joint state of opposite ends (a connection shaft for a motor and a connection shaft for an engine) can be recognized through the engine and motor load torque calculator, and a load torque change by which an instantaneous change state of an engine and motor system can be recognized are input to the fuzzy controller, the fuzzy controller generates and outputs a base hydraulic pressure (P_base) for jointing the engine clutch.

Further, a hydraulic pressure increment Del P is determined through Equation 3 to reach a joint target.

Del P=H*(Pmax−P_base) Equation 3

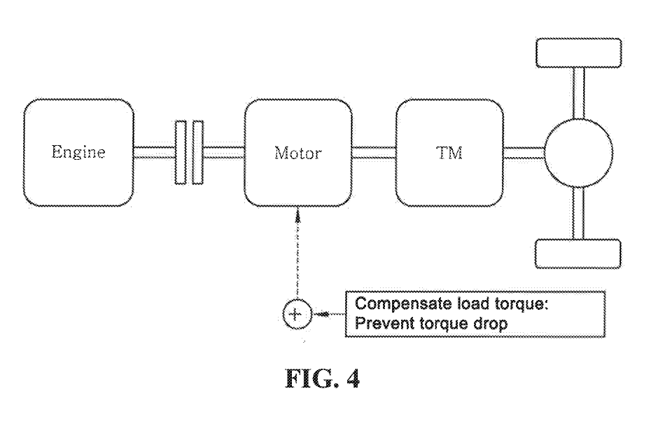

In particular, a pressure Del P necessary for an increment is determined by comparing a base hydraulic pressure P_base and a maximum lock-up hydraulic pressure Pmax generated through the fuzzy controller. Then, an additionally necessary pressure increment Del P is finally corrected by reflecting a transfer torque index H, and a maximum hydraulic pressure limit value P for reaching a joint target is as in FIG. 4.

P=P_base+Del_{—}P Equation 4

Thus, a control for reaching a joint target of the engine clutch may be performed by a hydraulic pressure to which a hydraulic pressure increment is applied, in addition to a base pressure.

While the present invention has been described with respect to the specific embodiments, it will be apparent to those skilled in the art that various changes and modifications may be made without departing from the spirit and scope of the invention as defined in the following claims.

What is claimed is:

1. A system for controlling a fuzzy engine clutch of a hybrid vehicle, the system comprising:
a load torque calculator for calculating a load torque based on a load difference of a load subject and a compensation subject, and compensating the load torque for the compensation subject;
a torque controller for transferring output information for a power source, and controlling a transmission ratio; and
an engine clutch joint control fuzzy controller for determining a hydraulic pressure for jointing an engine clutch based on torque information input from the torque controller, including load torque information input from the load torque calculator.

2. The system of claim 2, wherein the fuzzy controller comprises:
a transfer torque index defining unit for defining a transfer torque index that is a parameter that associates a torque of input information with a hydraulic pressure of output information;
a hydraulic pressure calculating unit for calculating a hydraulic pressure by which a necessary torque for jointing the engine clutch can be transferred by using the defined transfer torque index; and
a determined hydraulic pressure output unit for determining and outputting a fine hydraulic pressure increment and a fine hydraulic pressure decrement, including a base hydraulic pressure.

3. A method of controlling a fuzzy engine clutch of a hybrid vehicle, the method comprising:
a step of calculating a load torque based on a load difference of a load subject and a compensation subject, and calculating a load torque for compensating the load torque for the compensation subject; and
a fuzzy control step of determining a hydraulic pressure for jointing an engine clutch based on the calculated load torque information and torque information input from a torque controller.

4. The method of claim 3, wherein the fuzzy control step comprises:
a step of defining a transfer torque index that is a parameter that associates a torque of input information with a hydraulic pressure of output information;
a step of calculating a hydraulic pressure by which a necessary torque for jointing an engine clutch can be transferred by using the defined transfer torque index; and
a determined hydraulic pressure output step of determining a hydraulic pressure increment and a hydraulic pressure decrement, including a base hydraulic pressure for jointing the engine clutch, based on the transfer torque index and a hydraulic pressure for transferring a necessary torque.

5. The method of claim 4, wherein the transfer torque index (H) is defined by [Demanding torque−Motor torque/Engine torque+Motor torque+Engine clutch load torque].

6. The method of claim 4, wherein the hydraulic pressure by which a necessary torque can be transferred by using the transfer torque index (H) is calculated by [P=H*Pmax], and Pmax is a hydraulic pressure that can be generated when a load torque is “0”.

7. The method of claim 4, wherein a hydraulic pressure increment (Del P) for satisfying a joint target in addition to a base hydraulic pressure (P_base) for jointing the engine clutch is determined through [Del P=H*(Pmax−P_base)].

8. A non-transitory computer readable medium containing program instructions executed by a processor on a controller, the computer readable medium comprising:
program instructions that calculate a load torque based on a load difference of a load subject and a compensation subject, and calculate a load torque for compensating the load torque for the compensation subject; and
program instructions that determine a hydraulic pressure for jointing an engine clutch based on the calculated load torque information and torque information input from a torque controller, so as to control a fuzzy engine clutch of a hybrid vehicle.

9. The computer readable medium of claim 8, further comprising:
program instructions that define a transfer torque index that is a parameter that associates a torque of input information with a hydraulic pressure of output information;
program instructions that calculate a hydraulic pressure by which a necessary torque for jointing an engine clutch can be transferred by using the defined transfer torque index; and
program instructions that determine a hydraulic pressure increment and a hydraulic pressure decrement, including a base hydraulic pressure for jointing the engine clutch, based on the transfer torque index and a hydraulic pressure for transferring a necessary torque.

10. The computer readable medium of claim 9, wherein the transfer torque index (H) is defined by [Demanding torque−Motor torque/Engine torque+Motor torque+Engine clutch load torque].

11. The computer readable medium of claim 9, wherein the hydraulic pressure by which a necessary torque can be transferred by using the transfer torque index (H) is calculated by [P=H*Pmax], and Pmax is a hydraulic pressure that can be generated when a load torque is “0”.

12. The computer readable medium of claim 9, wherein a hydraulic pressure increment (Del P) for satisfying a joint target in addition to a base hydraulic pressure (P_base) for jointing the engine clutch is determined through [Del P=H*(Pmax−P_base)].
